(19) United States
(12) Patent Application Publication
(10) Pub. No.: US 2019/0316613 A1
(43) Pub. Date: Oct. 17, 2019

(54) INTERNAL FLOW CONTROL USING PLASMA ACTUATORS

(71) Applicant: GM GLOBAL TECHNOLOGY OPERATIONS LLC, Detroit, MI (US)

(72) Inventors: Bahram Khalighi, Birmingham, MI (US); Taeyoung Han, Bloomfield Hills, MI (US)

(73) Assignee: GM GLOBAL TECHNOLOGY OPERATIONS LLC, Detroit, MI (US)

(21) Appl. No.: 15/954,788

(22) Filed: Apr. 17, 2018

(51) Int. Cl. F15D 1/00; F15D 1/06

(52) U.S. Cl. CPC F15D 1/0075; F15D 1/06

(57) ABSTRACT

System are provided for internal flow control using plasma actuators. In various exemplary embodiments, a system for fluid flow includes a conduit that contains the fluid flow internally. The conduit has a geometry change through which the fluid flow is channeled. A plasma actuator is disposed in contact with the fluid flow to generate a jet flow in the fluid flow to influence the fluid flowing through the geometry change.

### INTRODUCTION

The present disclosure generally relates to flow control within enclosed conduits and more particularly, relates to internal flow control using plasma actuators.

Fluids are employed in numerous applications to accomplish a wide variety of tasks. For example, fluids may be used as a medium to transfer or otherwise influence heat, power, position, condition, or other parameters. Conduits of various forms are often used to define internal fluid flow passages for moving fluids and within which, fluid properties typically vary from place to place. This is because the routing of these conduits typically involves bends, expansions, convergences, divergences, elevation changes, and other changes that present challenges to the flow such as obstructions and other resistances. The underlying source of the resistance is often flow results that impede flow. The resistances may result in undesirable performance and/or energy losses. For example, in a flow system with a pump, the pump is sized to provide the required flow to the delivery points taking into account the total losses. Reducing the losses enables reducing the pump size or operating the pump using less energy.

Accordingly, it is desirable to minimize flow losses for a broad range of flow applications to provide improved performance and/or to consume less energy. Furthermore, other desirable features and characteristics of internal flow control will become apparent from the subsequent detailed description and the appended claims, taken in conjunction with the accompanying drawings and the foregoing technical field and background.

### SUMMARY

Systems are provided for internal fluid flow control using plasma actuators. In various embodiments, a system for fluid flow includes a conduit configured to contain the fluid flow internally, wherein the conduit has a geometry change through which the fluid flow is channeled. A plasma actuator disposed in contact with the fluid flow and is configured to generate a jet flow in the fluid flow to influence the fluid flow passing through the geometry change.

In an additional embodiment, the plasma actuator includes an exposed electrode in contact with the fluid flow, a hidden electrode spaced apart from the exposed electrode, and a patch of dielectric material separating the hidden electrode from the fluid flow and from the exposed electrode.

In an additional embodiment, a power supply is coupled with the exposed electrode and with the hidden electrode. The power supply is configured to vary a voltage supplied to the plasma actuator to vary the jet flow that is generated.

In an additional embodiment, the hidden electrode is disposed downstream from the exposed electrode relative to the fluid flow so that the jet flow is generated in a common direction with the fluid flow.

In an additional embodiment, the hidden electrode is disposed upstream from the exposed electrode relative to the fluid flow so that the jet flow is generated in a direction opposite the fluid flow.

In an additional embodiment, the plasma actuator extends completely around the conduit at the geometry change.

In an additional embodiment, the conduit branches into separate first and second paths. The plasma actuator is positioned adjacent the first path and is configured to increase a proportion of the fluid flow that enters the first path as compared that entering to the second path.

In an additional embodiment, the geometry change includes a bend in the conduit. The plasma actuator is disposed upstream in the fluid flow from the bend, and the bend effects a change in a direction of the fluid flow. The plasma actuator is disposed on an inside of the bend.

In an additional embodiment, the plasma actuator is disposed in a plug located on only one side of the conduit.

In a number of other embodiments, a system for fluid flow includes a conduit that has a wall configured to contain the fluid flow internally within the wall. The conduit has a geometry change through which the fluid flow is channeled, wherein the geometry change influences the fluid flow. A plasma actuator is disposed in contact with the fluid flow and is configured to generate a jet flow in the fluid flow to inhibit the creation of flow separation and recirculation by the geometry change.

In a number of additional embodiments, a system for fluid flow includes a conduit configured to contain the fluid flow internally, wherein the conduit has a geometry change through which the fluid flow is channeled. A plasma actuator is disposed in contact with the fluid flow and is configured to generate a jet flow in the fluid flow to influence the fluid flow passing through the geometry change. The plasma actuator includes an exposed electrode in contact with the fluid flow, a hidden electrode spaced apart from the exposed electrode, and a patch of dielectric material separating the hidden electrode from the fluid flow and from the exposed electrode. A power supply is coupled with the exposed electrode and with the hidden electrode. The power supply includes a power source and a boost converter to increase voltage, and is configured to supply a voltage to the plasma actuator to generate the jet flow.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic cross-sectional illustration of a plasma actuator for flow control in a conduit, in accordance with an embodiment;

FIG. 2 is a schematic illustration of a plasma actuator with power supply, in accordance with an embodiment;

FIG. 3 is a schematic cross-sectional illustration of a plasma actuator for flow control in a conduit, in accordance with an embodiment;

FIG. 4 is a schematic perspective illustration of an intake manifold application for a plasma actuator, in accordance with an embodiment;

FIG. 5 is a schematic cross-section illustration of the intake manifold of FIG. 4, in accordance with an embodiment;

FIG. 6 is a schematic perspective illustration of a catalytic converter system application for a plasma actuator, in accordance with an embodiment;

FIG. 7 is a schematic cross-section illustration of the catalytic converter system of FIG. 6 with a plasma actuator, in accordance with an embodiment;

FIG. 8 is a schematic illustration of the catalytic converter system of FIG. 6 with a plasma actuator, in accordance with an embodiment;

FIG. 9 is a schematic illustration of a branched conduit with plasma actuator, in accordance with an embodiment; and

FIG. 10 is a schematic illustration of a conduit system with plasma actuators, in accordance with an embodiment.

### DETAILED DESCRIPTION

The following detailed description is merely exemplary in nature and is not intended to limit the subject matter of the application or its uses. Furthermore, there is no intention to be bound by any expressed or implied theory presented in the preceding introduction, summary or the following detailed description.

In accordance with the preferred embodiments described herein, flow control is accomplished using dielectric barrier discharge (DBD) plasma actuators that may be applied for various internal flow control strategies such as attached flow, separated flow, and vortex generations. One example involves mitigating flow separation and recirculation for improved flow through internal passages. The plasma actuators each include at least two electrodes offset and separated by a dielectric material. One electrode, referred to as the hidden electrode is encapsulated in the dielectric material and the other electrode, referred to as the exposed electrode, is exposed to the flowing fluid. In other embodiments, multiple hidden electrodes may be used. When power is applied to the electrodes, a plasma originates at the exposed electrode and spreads across the surface of the dielectric material over the area of the hidden electrode. The plasma produces a jet flow away from the exposed electrode across the hidden electrode. The jet flow is used to control aspects of the flowing fluid as further described below. For example, the plasma actuators may be used to minimizing flow separation and recirculation, thereby improving performance of conduit systems and reducing the amount of energy that is consumed to move fluids. The plasma actuators may be used to control flow in a variety of applications with conduits that contain a flowing fluid such as ducts, pipes, manifolds, ports, diffusers, and others. In mobile applications such as vehicle fluid systems, this results in improved fuel economy, reductions of emissions and CO₂ foot print by reduced power consumption, and improved flow efficiency. Plasma actuator internal flow control is also tunable to provide flow noise reduction by eliminating flow separation and recirculation.

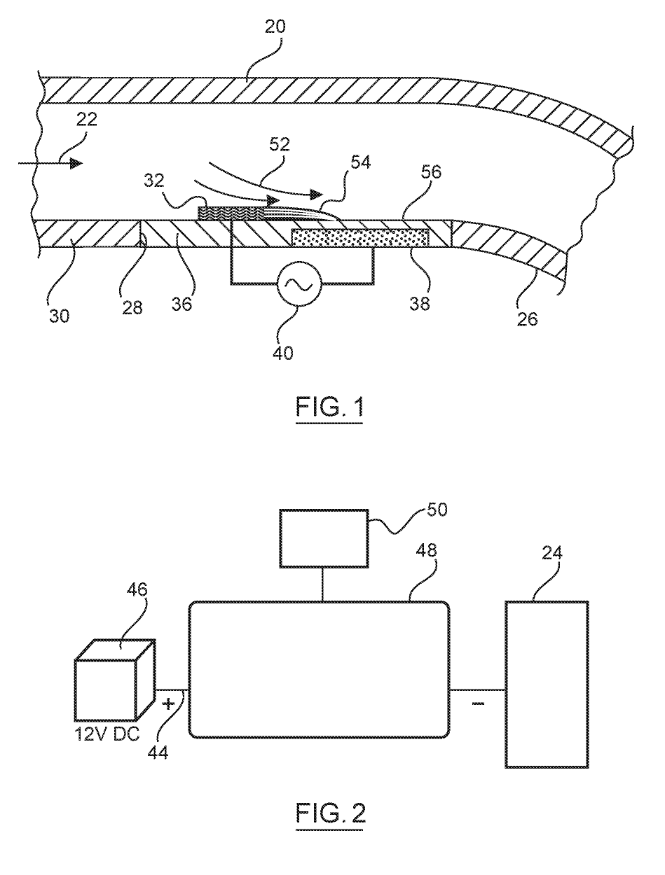

In an exemplary embodiment as illustrated in FIG. 1, a conduit 20 in the form of an enclosed duct directs a fluid flow 22 from left to right as viewed. A plasma actuator 24 is disposed along the conduit 20 and in this example, is configured to reduce flow losses that might otherwise arise due to a geometry change 26 in the conduit 20. In this example, the geometry change 26 comprises a bend in the conduit, which changes the direction of the fluid flow 22. The plasma actuator 24 is a DBD type and is disposed as a plug in an opening 28 through the wall 30 of the conduit 20. The plasma actuator 24 is located on the inside of the bend created by geometry change 26 and is immediately before the beginning of the geometry change 26. The plasma actuator 24 includes an exposed electrode 32 that is exposed to the fluid flow 22 and in this example, is positioned inside the inner surface 34 of the wall 30. A patch 36 of dielectric material is positioned in the opening 28 and completely closes the opening. In other examples, the patch 36 is disposed on the inside surface 34 of the wall 30, with the wall 30 serving as a substrate supporting the patch 36. The plasma actuator 24 includes a hidden electrode 38 that is encapsulated in the dielectric material of the patch 36. The electrodes 32, 38 are separated by the dielectric material of the patch 36. A power supply 40 is coupled with the electrodes 32, 38. Performance of plasma actuator 24 is determined by the type dielectric material used and by the power input. The dielectric material may be selected from a wide range of known materials.

Referring additionally to FIG. 2, an exemplary power supply 40 includes a power source 42, which in this embodiment is a 12-volt DC power bus 44 of a vehicle that is connected with a rechargeable battery 46. Coupled between the 12-volt power bus 44 and the plasma actuator 24, a power electronics module 48 includes a circuit with at least one DC-DC boost converter 50 with solid state switching, other power conditioning equipment as needed for the application. A controller 50 is provided to control the power electronics module 48, such as to vary the voltage level supplied to the plasma actuator 24. The voltage supply is coupled across the two electrodes 32, 38. To control fluid flow through the plasma actuator 24 the voltage is applied, typically in a range of multiple Kilovolts, such as ten Kilovolts at low current, such as 0.2 amperes. As a result, power consumption is very low, in the range of less than ten watts. The driving voltage waveform may be varied to produce different effects on the fluid flow 22. In response to the applied voltage, the electrodes 32, 38 generate a wall bounded jet flow 52, without the use of any moving parts. In this example, the jet flow 52 is in the same direction as the fluid flow 22 and reduces flow losses through the geometry change 26. The jet flow 52 results from a plasma 54 that originates at the exposed electrode 32 and spreads across the surface 56 of the dielectric material of the patch 36, over the area of the hidden electrode 38. The velocity of the jet flow 52 is variable by varying the supplied voltage to the plasma actuator 24. To arrive at a selection for the optimum dielectric material to use and the power supply characteristics for the desired effect on the fluid flow 22, the conduit 20 with the plasma actuator 24 and the power supply 40 is constructed physically or virtually. Different dielectric materials and voltage levels are tested or modeled. The optimum location for the plasma actuator 24 is determined by processes such as testing, flow visualization or computational fluid dynamics. During the evaluations, the plasma actuator 24 is assembled at the determined location of the conduit 20. Flow performance is then evaluated for various frequencies, pulse durations, voltage levels and separately for different dielectric materials. The results are then evaluated to select the optimal power supply characteristics and dielectric material.

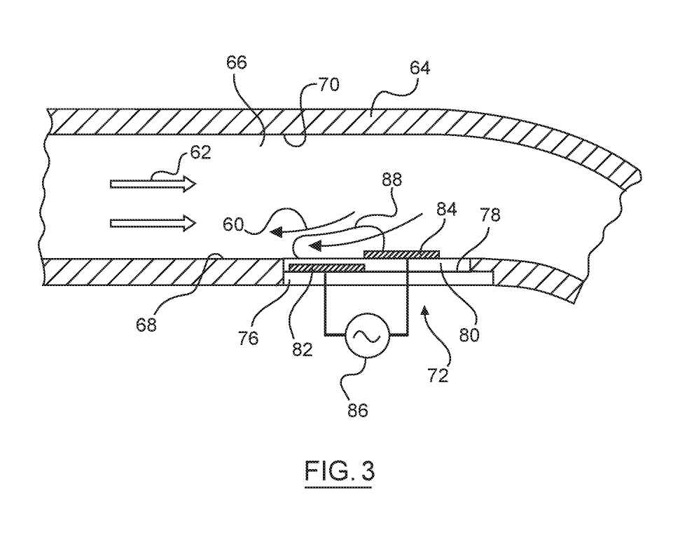

Referring to FIG. 3, an embodiment is illustrated showing a jet flow 60 that is generated in a direction that is opposite to the direction of the fluid flow 62 in a conduit 64. The conduit 64 defines an internal space 66 through which the fluid flow 62 is channeled. The objective of this embodiment is to influence the fluid flow 62 in ways other than reducing separation losses. For example, the jet flow 60 resists the fluid flow 62 creating flow opposition on the side 68 of the conduit 64 which may be used to direct a larger percentage of the flow to the opposite side 70 of the conduit 64. In other embodiments, the resistance of the jet flow 60 is used to slow the fluid flow 62 at the plasma actuator 72.

The conduit 64 includes a wall 74 that defines the internal space 66 and that has an area 76 of reduced thickness within which the plasma actuator 72 is positioned. The area 76 forms a recess 78 in the wall 74 on the inside of the conduit 64 and serves as a substrate upon which the plasma actuator 72 is disposed. A patch 80 of dielectric material is disposed in the recess 78 with a hidden electrode 82 encapsulated in the patch 80 and thereby separated from the fluid flow 62. An exposed electrode 84 is exposed to the fluid flow 62, is separated from the hidden electrode 82 by the dielectric material of the patch 80, and is positioned downstream from the hidden electrode 82. A power supply 84 is coupled with the electrodes 82, 84.

In response to the applied voltage from the power supply 84, the electrodes 82, 84 generate the jet flow 60. The jet flow 60 results from a plasma 88 that originates at the exposed electrode 84 and spreads across the surface 90 of the dielectric material of the patch 80, over the area of the hidden electrode 82. In this example, the jet flow 86 is in an opposite direction from the fluid flow 62 and creates a resistance area 88 that inhibits the fluid flow 62. The resistance area 88 may be used to direct a greater percentage of the fluid flow 62 to the opposite side 70 of the conduit 64, to slow the fluid flow 62, or for other effects that result from the oppositely directed jet flow 60.

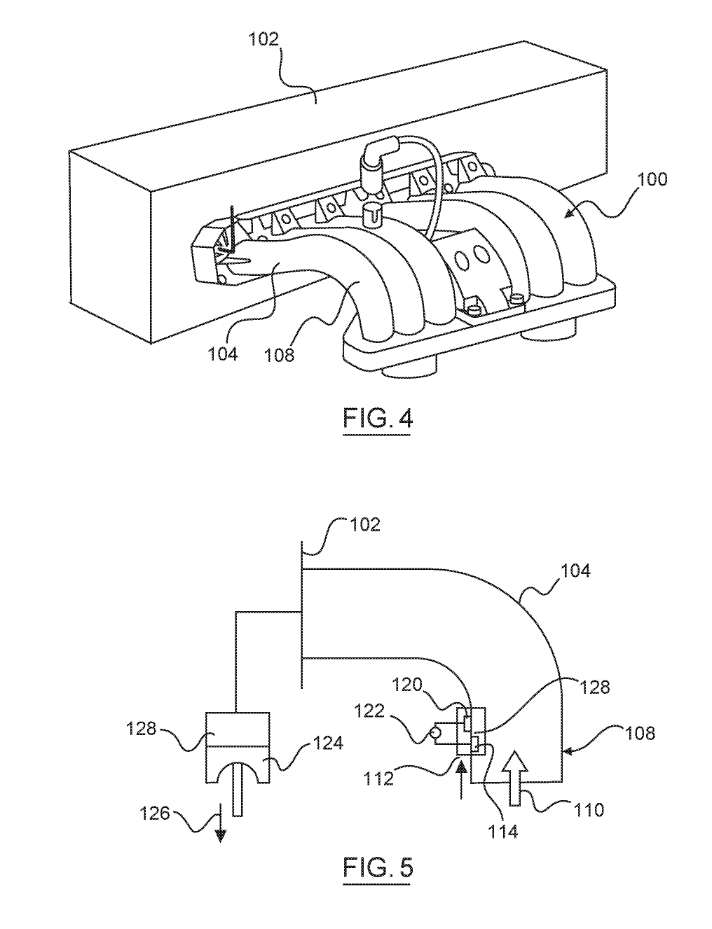

An embodiment that includes an intake manifold 100 of an engine 102 is illustrated in FIG. 4. In the engine 102, air is drawn into the combustion chambers by reciprocating pistons that act as pumps. During a piston intake stroke, air pressure in the intake manifold 100 is lowered below atmospheric pressure to draw air in. The piston is required to do work to move the air through the system and the required work results in inefficiencies called pumping losses. The intake manifold 100 includes bends 104 that may result in flow separation and recirculation that may increase pumping losses. In this embodiment, plasma actuators 106 are included to reduce pumping losses. With additional reference to FIG. 5, conduit 108 includes plasma actuator 106 to for example, reduce internal flow separation, recirculation, and to decrease pumping losses.

The conduit 108 of the intake manifold 100 is an enclosed duct that directs air flow 110 toward the engine 102. The plasma actuator 106 is disposed along the conduit 108 and in this example, is configured to reduce flow losses that might otherwise arise due to the bend 104 in the conduit 108. The plasma actuator 106 is a DBD type and is disposed on a wall 112 of the conduit 108. The plasma actuator 106 is located on the inside of the bend 104 and is immediately before the beginning of the geometry change. The plasma actuator 106 includes an exposed electrode 114 that is exposed to the air flow 110 and in this example, is positioned inside the inner surface 116 of the wall 112. A patch 118 of dielectric material is positioned on the inside surface 116 of the wall 112, with the wall 112 serving as a substrate supporting the patch 118. The plasma actuator 106 includes a hidden electrode 120 that is encapsulated in the dielectric material of the patch 118. The electrodes 114, 120 are separated by the dielectric material of the patch 118. A power supply 122 is coupled with the electrodes 114, 120. In operation, when the piston 124 in the engine 102 moves in a direction 126 to expand the combustion chamber 128, air is drawn through the conduit 108 of the intake manifold 100. The power supply 122 supplies current to the electrodes 114, 120 when the piston 124 moves in the direction 126 creating a plasma 128 that reduces separations improving air flow 110 and reducing the amount of energy expended by the engine 102 to move the air into the combustion chamber 128. When the piston 124 is not in an intake stroke the power supply 122 turns off the voltage to the plasma actuator 106.

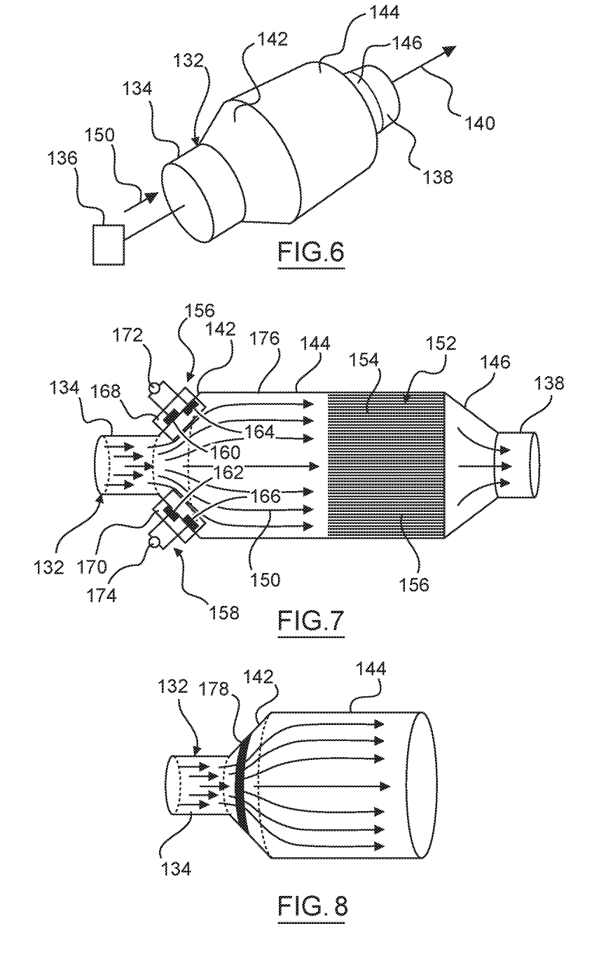

Referring to FIG. 6, an embodiment is illustrated for a catalytic converter system 130 application. The catalytic converter system 130 includes a conduit 132 in the form of an exhaust pipe that has an incoming segment 134 that channels exhaust gas received from an engine 136 and an outgoing segment 138 that directs the conditioned exhaust gas 140 to atmosphere. The conduit 132 includes a geometry change 142 in the form of a flared expansion leading to a segment 144 with a larger diameter than that of the incoming segment 134. Following the segment 144 the conduit 132 includes another geometry change 146 in the form of a reducing flared segment that leads to the outgoing segment 138. Exhaust flow 150 from the engine 136 passes through the incoming segment 134 and the geometry change 142 and into the segment 144 where the exhaust flow 150 slows in speed due to the larger flow area.

Referring additionally to FIG. 7, a cross section of the catalytic converter system 130 is shown, which includes a monolithic type catalyst support 152 in the segment 144. The catalyst support 152 is a structure that serves as a core of the catalytic converter system 130 with parallel flow channels 154 defined by separating walls 156. The flow channels may take a number of different shapes such as rectangular, square, hexagonal, round, or other shapes to provide a large amount of surface area containing a catalyst. High surface area facilitates catalytic reaction and the catalytic converter system works most effectively if the exhaust flow 150 is distributed to all the flow channels 154. The exhaust flow 150, without control, may result in flow separation and recirculation at the geometry change 142 that inhibits even distribution of flow across the catalyst support 152.

To reduce flow separation and recirculation caused by the geometry change 142, plasma actuators 156, 158 are disposed on the conduit in the geometry change 142. The plasma actuators 156, 158 are similar to the plasma actuator 24 described above in relation to FIG. 1 and each includes an exposed electrode 160, 162, a hidden electrode 164, 166, a patch 168, 170 of dielectric material and a power supply 172, 174 (or a common power supply). The plasma actuators 156, 158 are tuned to evenly distribute the exhaust flow 150 within the segment 144 for entry into the flow channels 154, including those near the wall 176 of the segment 144. FIG. 8 illustrates an alternative embodiment of the catalytic converter system 130 that includes a plasma actuator 178 that completely encircles the geometry change 142. The plasma actuator 178 is similar in construction to the plasma actuator 24 described above in relation to FIG. 1 except for its annular shape. Providing the plasma actuator 178 completely around the geometry change 142 effects separation correction around the entire perimeter of the conduit 132 and assists in even distribution when the flow channels 154 are square, hexagonal or round in shape.

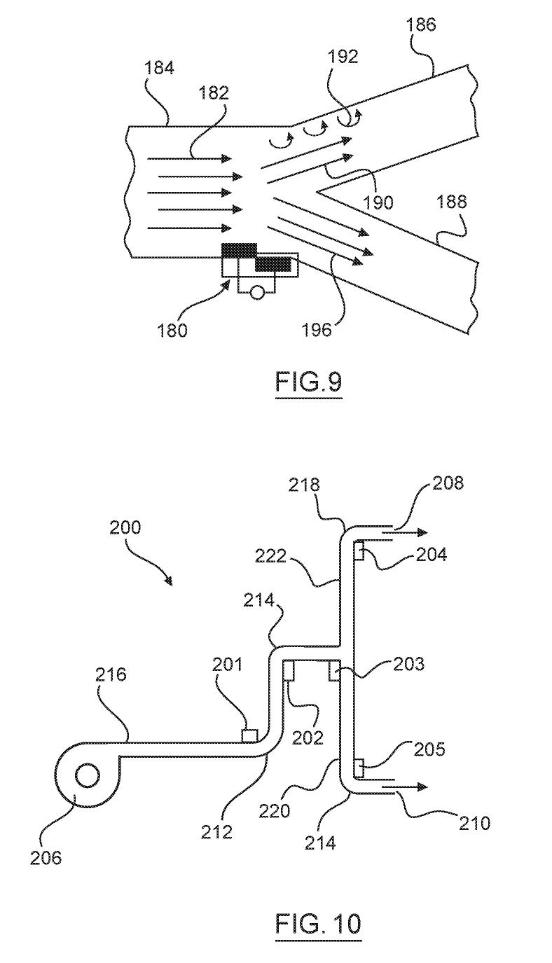

As shown in FIG. 9, a plasma actuator 180 is disposed in a flow system to control the amount of fluid flow 182 distributed to diverging flow paths. A conduit 184 channels the fluid flow 182, which is split into two paths through conduits 186, 188. The plasma actuator 180 is similar in construction to the plasma actuator 24 described above in relation to FIG. 1 and is positioned at the end of the conduit 184 on its side adjacent the entry to the conduit 188. The portion 190 of the fluid flow 182 that enters the conduit 186 incurs flow separations/recirculation 192. The plasma actuator 180 is energized to reduce flow separation and recirculation in the portion 196 of the fluid flow 182 entering the conduit 188, reducing resistance and improving flow. As a result, the portion 196 is greater than the potion 190 and more of the fluid flow 182 is directed into the conduit 188 than into the conduit 186. In some embodiments, a plasma actuator configured similar to the plasma actuator of FIG. 3 is placed on the side of the conduit 184 adjacent the conduit 186 to oppose the fluid flow 182 and thereby direct a greater percentage of the fluid flow 182 into the conduit 188. In some embodiments, the plasma actuator 180 is actively controlled by varying the supplied voltage, which varies the generated jet flow velocity to change the portion 196 of the fluid flow 182 that is directed into the conduit 188.

A conduit system 200 is illustrated in FIG. 10 with multiple plasma actuators 201-205, each of which is similar in construction to the plasma actuator 24 described above in relation to FIG. 1. In this exemplary embodiment, the conduit system 200 is a part of a HVAC system for a vehicle and includes a pump in the form of a blower 206 and two vent diffusers 208, 210. The plasma actuator 201 is positioned prior to a bend 212 and operates to reduce flow losses. The plasma actuator 202 is positioned prior to a bend 214 and also operates to reduce flow losses. The plasma actuator 203 is positioned at the end of conduit 216 on its side adjacent the conduit 220 and operates to control the proportion of flow into the conduit 220 in relation to the proportion into the conduit 218. Use of the plasma actuator 203 rather than a damper or other obstructive flow control device distributes flow between the conduits 218, 220 without adding flow losses. The plasma actuator 204 is positioned prior to a bend 222 and operates to reduce flow losses. Similarly, the plasma actuator 205 is positioned prior to a bend 224 and operates to reduce flow losses. Inclusion of the plasma actuators 201-205 reduces flow losses in the conduit system 200 resulting in lower power consumption by the blower 206. In addition, the size of the blower 206 may be reduced as compared to one in a system without the plasma actuators 201-205.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system for fluid flow comprising:
a conduit configured to contain the fluid flow internally, wherein the conduit has a geometry change through which the fluid flow is channeled; and
a plasma actuator disposed in contact with the fluid flow and configured to generate a jet flow in the fluid flow to influence the fluid flow passing through the geometry change.

2. The system of claim 1 wherein the plasma actuator includes an exposed electrode in contact with the fluid flow, a hidden electrode spaced apart from the exposed electrode, and a patch of dielectric material separating the hidden electrode from the fluid flow and from the exposed electrode.

3. The system of claim 2 comprising a power supply coupled with the exposed electrode and the hidden electrode, wherein the power supply is configured to vary a voltage supplied to the plasma actuator to vary the jet flow that is generated.

4. The system of claim 2 wherein the hidden electrode is disposed downstream from the exposed electrode relative to the fluid flow so that the jet flow is generated in a common direction with the fluid flow.

5. The system of claim 2 wherein the hidden electrode is disposed upstream from the exposed electrode relative to the fluid flow so that the jet flow is generated in a direction opposite the fluid flow.

6. The system of claim 1 wherein the plasma actuator extends completely around the conduit at the geometry change.

7. The system of claim 1 wherein the conduit branches into separate first and second paths and the plasma actuator is positioned adjacent the first path and is configured to increase a proportion of the fluid flow that enters the first path as compared to the second path.

8. The system of claim 1 wherein the plasma actuator is configured to generate the jet flow in a direction that is opposite to the fluid flow.

9. The system of claim 1 wherein the geometry change comprises a bend in the conduit and wherein the plasma actuator is disposed upstream in the fluid flow from the bend, and wherein the bend effects a change in a direction of the fluid flow and the plasma actuator is disposed on an inside of the bend.

10. The system of claim 1 wherein the plasma actuator is disposed in a plug located on one side only, of the conduit.

11. A system for fluid flow comprising:
a conduit having a wall configured to contain the fluid flow internally within the wall, wherein the conduit has a geometry change through which the fluid flow is channeled, wherein the geometry change influences the fluid flow; and
a plasma actuator disposed in contact with the fluid flow and configured to generate a jet flow in the fluid flow to inhibit the creation of flow separation and recirculation by the geometry change.

12. The system of claim 11 wherein the plasma actuator includes an exposed electrode in contact with the fluid flow, a hidden electrode spaced apart from the exposed electrode, and a patch of dielectric material separating the hidden electrode from the fluid flow and from the exposed electrode.

13. The system of claim 12 comprising a power supply coupled with the exposed electrode and the hidden electrode, wherein the power supply is configured to vary a voltage supplied to the plasma actuator to vary the jet flow that is generated.

14. The system of claim 12 wherein the hidden electrode is disposed downstream from the exposed electrode relative to the fluid flow so that the jet flow is generated in a common direction with the fluid flow.

15. The system of claim 12 wherein the hidden electrode is disposed upstream from the exposed electrode relative to the fluid flow so that the jet flow is generated in a direction opposite the fluid flow.

16. The system of claim 11 wherein the plasma actuator extends completely around the conduit at the geometry change.

17. The system of claim 11 wherein the conduit branches into separate first and second paths and the plasma actuator is positioned adjacent the first path and is configured to increase a proportion of the fluid flow that enters the first path as compared to the second path.

18. The system of claim 11 wherein the plasma actuator is configured to generate the jet flow in a direction that is opposite to the fluid flow.

19. The system of claim 11 wherein the geometry change comprises a bend in the conduit and wherein the plasma actuator is disposed upstream in the fluid flow from the bend, and wherein the bend effects a change in a direction of the fluid flow and the plasma actuator is disposed on an inside of the bend.

20. A system for fluid flow comprising:
a conduit configured to contain the fluid flow internally, wherein the conduit has a geometry change through which the fluid flow is channeled;
a plasma actuator disposed in contact with the fluid flow and configured to generate a jet flow in the fluid flow to influence the fluid flow passing through the geometry change, wherein the plasma actuator includes an exposed electrode in contact with the fluid flow, a hidden electrode spaced apart from the exposed electrode, and a patch of dielectric material separating the hidden electrode from the fluid flow and from the exposed electrode: and
a power supply coupled with the exposed electrode and the hidden electrode, wherein the power supply includes a power source and a boost converter to increase voltage, and wherein the power supply is configured to supply a voltage to the plasma actuator to generate the jet flow.
